(19) United States
(12) Patent Application Publication
(10) Pub. No.: US 2018/0270246 A1
(43) Pub. Date: Sep. 20, 2018

(54) INFORMATION PROCESSING SYSTEM, INFORMATION PROCESSING APPARATUS, AND INFORMATION PROCESSING METHOD

(71) Applicants: Yasuharu FUKUDA, Kanagawa (JP); Hiroki OHZAKI, Kanagawa (JP)

(72) Inventors: Yasuharu FUKUDA, Kanagawa (JP); Hiroki OHZAKI, Kanagawa (JP)

(73) Assignee: Ricoh Company, Ltd., Tokyo (JP)

(21) Appl. No.: 15/915,528

(22) Filed: Mar. 8, 2018

(30) Foreign Application Priority Data
Mar. 15, 2017 (JP) 2017-049849

(51) Int. Cl. H04L 29/06

(52) U.S. Cl. CPC H04L 63/102; G06F 3/0484; H04L 63/0876

(57) ABSTRACT

An information processing system includes at least one information processing apparatus that includes: a first memory configured to store toggle information that includes entity information indicating either identification information of organizations or identification information of devices and includes identification information of one or more services provided via a network; and a processor coupled to the memory and configured to obtain, upon receiving a service use request from a given device coupled to the information processing system, from the toggle information stored in the first memory, toggle information that includes entity information indicating either identification information of an organization to which a user of the given device belongs or identification information of the given device, generate data for displaying one or more of the services indicated by the identification information of the services included in the obtained toggle information as available, and send the generated data to the given device.

### CROSS-REFERENCE TO RELATED APPLICATION

The present application claims priority under 35 U.S.C. § 119 to Japanese Patent Application No. 2017-049849, filed on Mar. 15, 2017, the entire contents of which are incorporated herein by reference.

### BACKGROUND OF THE INVENTION

### 1. Field of the Invention

The disclosures herein generally relate to an information processing system, an information processing apparatus, and an information processing method.

### 2. Description of the Related Art

In recent years, companies adopting a cloud service are on the increase. A cloud service refers to a service provided by a cloud computing technology.

A need exists to provide a new service to a specific company or organization earlier than to other users. In order to meet such needs, a dedicated environment has been built for the specific company or organization such that the new service can be provided earlier than other users.

In a case where a dedicated environment is built for a specific company or organization, hardware costs and maintenance costs increase. Further, version control of programs that implement a service provided to the specific company or organization is required. Accordingly, a management cost also increases.

It is contemplated that the above-described needs can be met without building a dedicated environment by allowing a specific company or organization to use a new service while restricting the use of the new service by other users.

### RELATED-ART DOCUMENTS

### Patent Document

[Patent Document 1] Japanese Unexamined Patent Application Publication No. 2015-111407

### SUMMARY OF THE INVENTION

In view of the above, it is a general object of at least one embodiment of the present invention to flexibly set restrictions on the use of a service according to an entity.

According to an aspect of at least one embodiment, an information processing system includes at least one information processing apparatus that includes: a first memory configured to store toggle information that includes entity information indicating either identification information of organizations or identification information of devices and includes identification information of one or more services provided via a network, the one or more services each being associated with at least one of the organizations or the devices; and a processor coupled to the memory and configured to obtain, upon receiving a service use request from a given device coupled to the information processing system via a network, from the toggle information stored in the first memory, toggle information that includes entity information indicating either identification information of an organization to which a user of the given device belongs or identification information of the given device, generate data for displaying one or more of the services indicated by the identification information of the services included in the obtained toggle information as available, and send the generated data to the given device.

### BRIEF DESCRIPTION OF THE DRAWINGS

FIG. 1 is a diagram illustrating an example of a configuration of an information processing system according to an embodiment;

FIG. 2 is a diagram illustrating an example of a hardware configuration of a computer;

FIG. 3 is a diagram illustrating an example of a hardware configuration of an image forming device according to the embodiment;

FIG. 4 is a processing block diagram illustrating an example of a service providing system according to the embodiment;

FIG. 5 is a configuration diagram illustrating an example of tenant information;

FIG. 6 is a configuration diagram illustrating an example of user information;

FIG. 7 is a configuration diagram illustrating an example of device information;

FIG. 8 is a configuration diagram illustrating an example of application information;

FIG. 9 is a configuration diagram illustrating an example of feature information;

FIG. 10 is a configuration diagram illustrating an example of feature toggle information;

FIG. 11 is a diagram illustrating a logical configuration of a feature toggle;

FIG. 12 is a sequence diagram illustrating an example of a process of automatically switching displays of available features using a feature toggle;

FIGS. 13A and 13B are examples of screens in cases where a feature A is enabled and disabled, respectively;

FIG. 14 is a sequence diagram illustrating another example of a process of automatically switching displays of available features using a feature toggle;

FIGS. 15A and 15B are other examples of screens in cases where a feature A is enabled and disabled, respectively;

FIG. 16 is a diagram illustrating a workflow for providing a service to a specific user earlier than other users; and

FIG. 17 is a diagram illustrating a workflow for providing a service to all users.

### DESCRIPTION OF THE PREFERRED EMBODIMENTS

In the following, embodiments of the present invention will be described with reference to the accompanying drawings.

### <System Configuration>

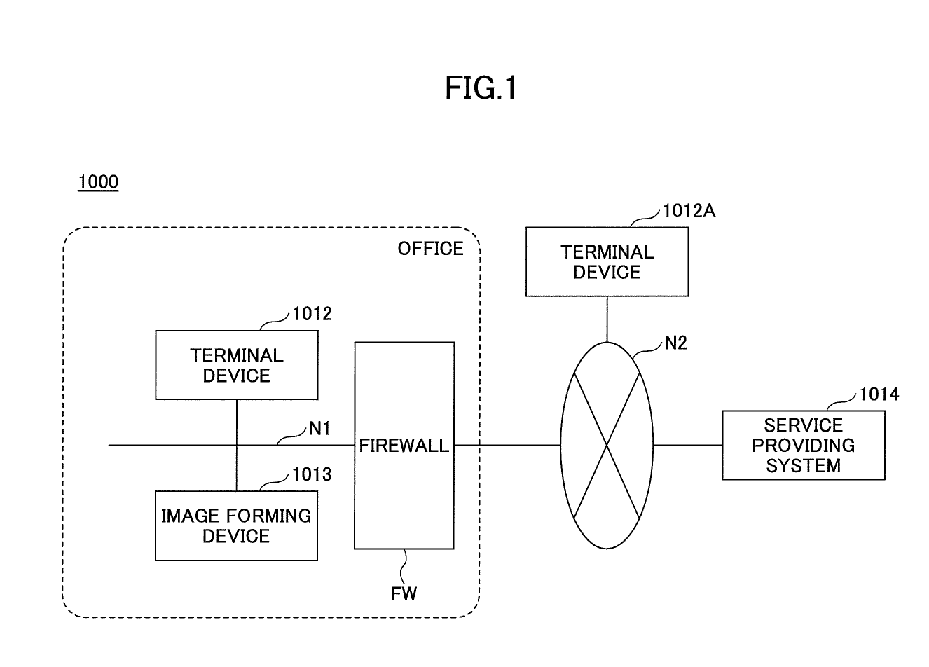

FIG. 1 is a diagram illustrating an example of a configuration of an information processing system 1000 of an embodiment. The information processing system 1000 in FIG. 1 includes a network N1 such as an intra-office network and a network N2 such as the Internet, for example.

The network N1 is a private network located inside of a firewall FW. The firewall FW is installed at a boundary between the network N1 and the network N2. The firewall FW detects and blocks an unauthorized access. A terminal device 1012 such as a personal computer (PC) and an image forming device 1013 such as a multifunction peripheral are coupled to the network N1.

Examples of the terminal device 1012 include a smartphone, a mobile phone, a tablet terminal, a desktop PC, and a notebook PC on which a general operating system (OS) or the like is installed. The terminal device 1012 includes a wired or wireless communication link.

The image forming device 1013 is an apparatus including an image forming function. The image forming device 1013 includes a wired or wireless communication link. The image forming device 1013 is an apparatus configured to perform processes related to image formation, such as a multifunction peripheral (MFP), a copier, a scanner, a printer, a projector, and an electronic blackboard. As an example, FIG. 1 illustrates a single terminal device 1012 in the network N1 and a single image forming device 1013, but a plurality of terminal devices 1012 and a plurality of image forming devices 1013 may be used.

Further, the terminal device 1012 and a service providing system 1014 are coupled to the network N2. The terminal device 1012 may be coupled to an intra-office network and the like other than the network N1. FIG. 1 illustrates an example in which the terminal device 1012 is coupled to the network N1 and the network N2.

The service providing system 1014 includes at least one information processing apparatus. The service providing system 1014 is an example of an information processing system that provides any service to the terminal device 1012 and the image forming device 1013. On a per-tenant basis, the service providing system 1014 receives a login request from a user operating the terminal device 1012 and the image forming device 1013. The tenant refers to an organization, a group, and the like regarded as a unit. Examples of the tenant include a company, a department of a company, a group, and a team.

The service providing system 1014 provides a service to the terminal device 1012 and the image forming device 1013 that are operated by a user who has successfully logged in (login user).

### <Hardware Configuration>

### <<Computer>>

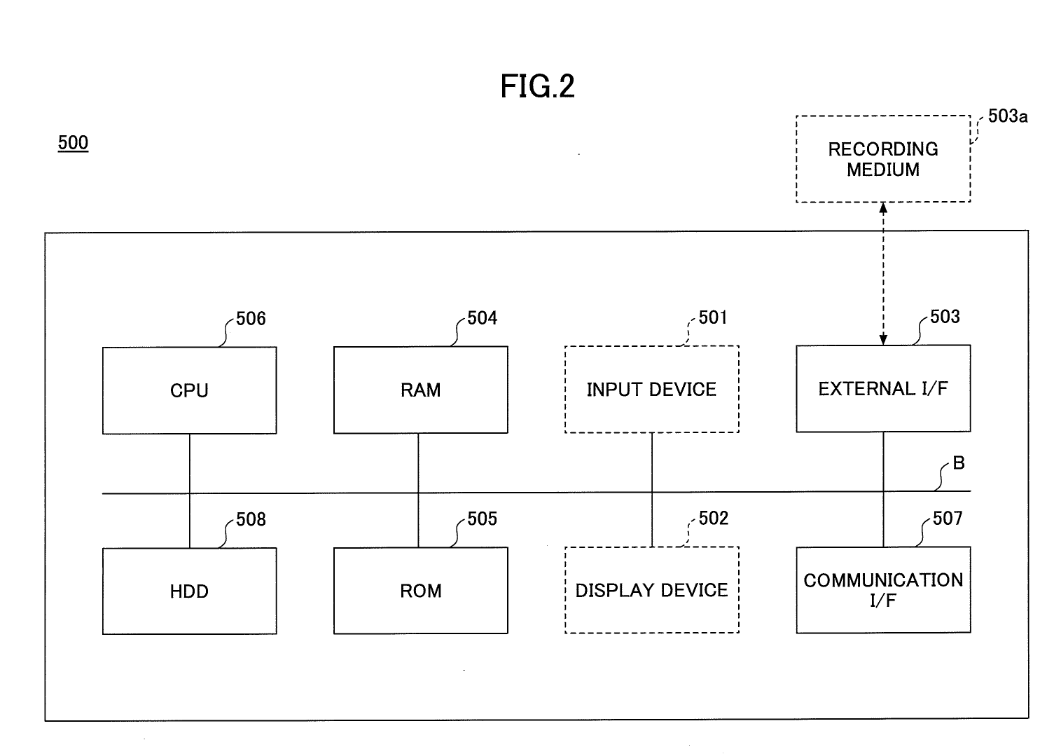

The terminal device 1012 is implemented by a computer 500 having, for example, a hardware configuration as illustrated in FIG. 2. Further, the at least one information processing apparatus included in the service providing system 1014 is also implemented by the computer 500.

FIG. 2 is a diagram illustrating an example of the hardware configuration of the computer 500. The computer 500 in FIG. 2 includes an input device 501, a display device 502, an external interface (I/F) 503, and random-access memory (RAM) 504. The computer 500 in FIG. 2 also includes read-only memory (ROM) 505, a central processing unit (CPU) 506, a communication interface (I/F) 507, and a hard disk drive (HDD) 508. These hardware components are coupled to each other via a bus B. Further, at least one of the input device 501 and the display device 502 may be coupled to the bus B when necessary.

The input device 501 includes a keyboard, a mouse, and a touch panel with which a user inputs various operation signals. The display device 502 includes a display that displays processing results obtained by the computer 500.

The communication interface (I/F) 507 is an interface that connects the computer 500 to various networks. The computer 500 can perform data communication via the communication interface (I/F) 507.

Further, the HDD 508 is an example of a non-volatile storage that stores programs and data. The programs and data stored in the HDD 508 include an OS, which is basic software controlling the entire computer 500, and application software running on the OS and providing various functions (hereinafter also simply referred to as “application software”). The computer 500 may use a drive device (a solid state drive (SSD), for example) using flash memory as a storage medium in place of the HDD 508.

The external interface (I/F) 503 is an interface with an external device. The external device includes a recording medium 503a. The computer 500 can read from and write to the recording medium 503a via the external interface (I/F) 503. The recording medium 503a includes a flexible disk, a compact disc (CD), a digital versatile disc (DVD), a secure digital (SD) memory card, and a universal serial bus (USB) memory.

The ROM 505 is an example of non-volatile semiconductor memory (storage) that can hold programs and data even when the power is turned off. The ROM 505 stores programs and data such as basic input/output system (BIOS), which are executed when the computer 500 is started, OS settings, and network settings. The RAM 504 is an example of volatile semiconductor memory (storage) that temporarily stores programs and data.

The CPU 506 is a processor that reads programs and data from storage such as the ROM 505 or the HDD 508 into the RAM 504 and performs operations so as to control the entire computer 500 and implement functions.

The at least one information processing apparatus implemented by the terminal device 1012 and the service providing system 1014 can perform various processes, which will be described later, by using the hardware configuration of the computer 500 illustrated in FIG. 2, for example.

### <<Image Forming Device>>

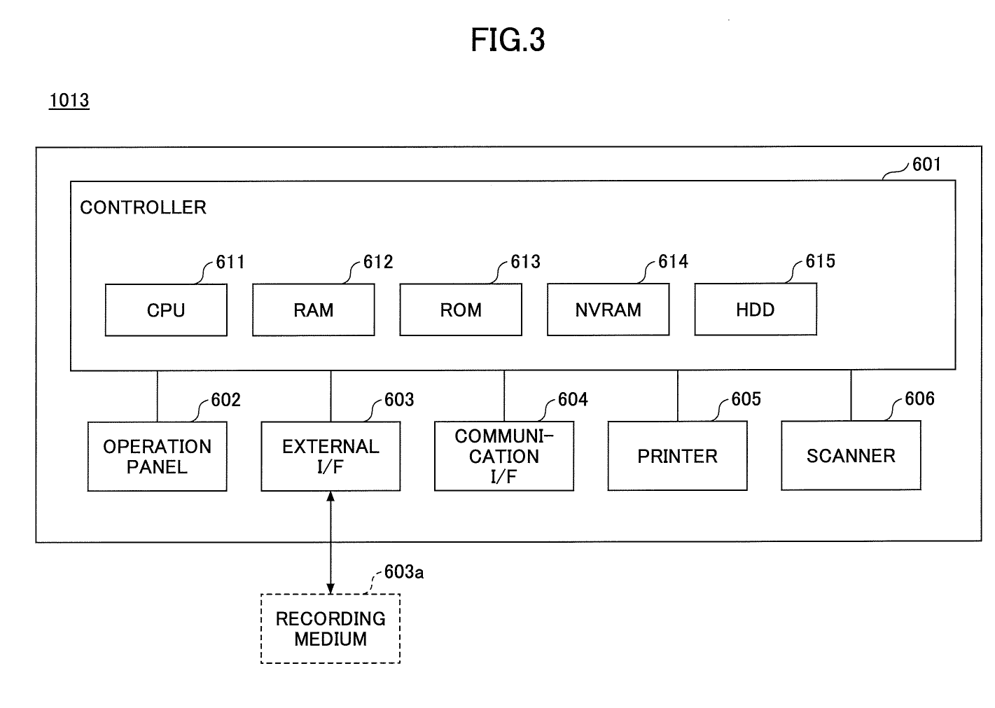

The image forming device 1013 in FIG. 1 has, for example, a hardware configuration illustrated in FIG. 3. FIG. 3 is a diagram illustrating an example of the hardware configuration of the image forming device 1013 according to the present embodiment.

The image forming device 1013 in FIG. 3 includes a controller 601, an operation panel 602, an external I/F 603, a communication interface (I/F) 604, a printer 605, and a scanner 606.

The controller 601 includes a CPU 611, RAM 612, ROM 613, NVRAM 614, and a HDD 615. The ROM 613 stores various programs and data. The RAM 612 temporarily holds programs and data. The NVRAM 614 stores setting information, for example. The HDD 615 stores various programs and data.

The CPU 611 reads programs and data from storage such as the ROM 613, the NVRAM 614, or the HDD 615 into the RAM 504 and performs operations so as to control the entire image forming device 1013 and implement functions.

The operation panel 602 is provided with an input device that receives an input from a user and a display. The external I/F 603 is an interface with an external device. The external device includes a recording medium 603a. The image forming device 1013 can read from and write to a recording medium 603a via the external I/F 603. The recording medium 603a includes an IC card, a flexible disk, a CD, a DVD, a SD memory card, and a USB memory. The communication interface (I/F) 604 is an interface that connects the image forming device 1013 to the network N1. The image forming device 1013 can perform data communication via the communication interface (I/F) 604. The printer 605 is a printing device for printing print data on an object to be carried. Examples of the object to be carried include paper, a coated paper, cardboard, an OHP sheet, a plastic film, prepreg, and a copper foil. The scanner 606 is a reading device that reads image data (electronic data) from a document.

The image forming device 1013 can perform various processes, which will be described later, by having the hardware configuration illustrated in FIG. 3, for example.

### <Software Configuration>

### <<Service Providing System>>

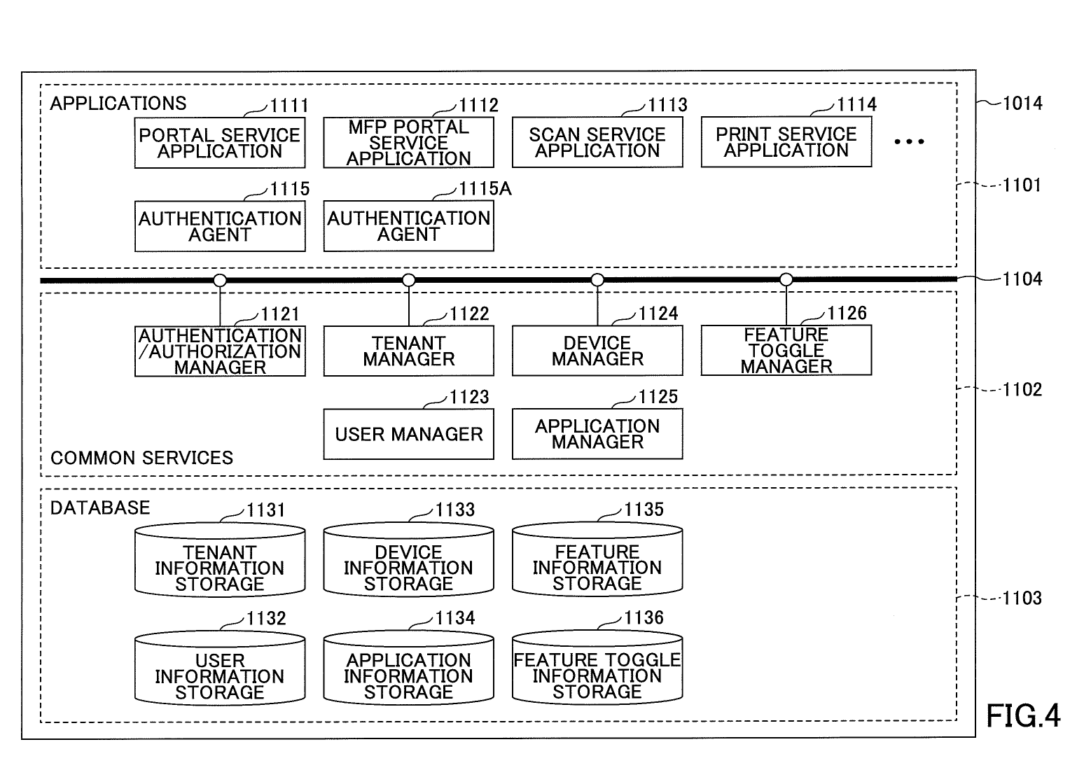

The service providing system 1014 according to the present embodiment is implemented by processing blocks illustrated in FIG. 4. FIG. 4 is a processing block diagram illustrating an example of the service providing system 1014 according to the present embodiment. The service providing system 1014 performs processing in the processing blocks as illustrated in FIG. 4 by executing programs.

The service providing system 1014 in FIG. 4 includes applications 1101, common services 1102, database (DB) 1103, and a platform API (Application Programming Interface) 1104.

The applications 1101 include a portal service application 1111, a MFP portal service application 1112, a scan service application 1113, a print service application 1114, and an authentication agent 1115, for example.

The portal service application 1111 is an application that provides a portal service to the terminal device 1012. The MFP portal service application 1112 is an application that provides a portal service to the image forming device 1013. The portal service is a service acting as an entrance for using the service providing system 1014.

The scan service application 1113 is an application that provides a scan service. The print service application 1114 is an application that provides a print service. The applications 1101 may include other service applications.

The authentication agent 1115 is a program that protects the portal service application 1111 and the MFP portal service application 1112 from an unauthorized request. The portal service application 1111 and the MFP portal service application 1112 are protected from an unauthorized request by the authentication agent 1115, and receive a request from, for example, the terminal device 1012 and the image forming device 1013 having authorized authentication information (such as an authentication ticket).

The applications 1101 generates a user interface (UI) displaying features (functions) available to an entity by referring to entity information such as tenant information, device information, user information, and application information as will be described later, and also by referring to feature toggle information as will be described later. By turning on or off a feature (function) available to entities with which the feature is associated (namely, by generating or by not generating an icon for using the feature), the applications 1101 of the present embodiment can restrict the use of the feature. A tenant, a device, a user, and an application are examples of an entity for which the use of a feature can be restricted using a feature toggle.

The platform API 1104 is an interface that allows the portal service application 1111, the MFP portal service application 1112, the scan service application 1113, and the print service application 1114 to use the common services 1102. The platform API 1104 is a predefined interface that allows the common services 1102 to receive a request from the applications 1101. For example, the platform API 1104 includes a function, a class, and the like.

In a case where the service providing system 1014 is configured with a plurality of information processing apparatuses, the platform API 1104 can be implemented by an interface (a web API, for example) that can be used over a network.

The common services 1102 include an authentication/authorization manager 1121, a tenant manager 1122, a user manager 1123, a device manager 1124, an application manager 1125, and a feature toggle manager 1126.

The authentication/authorization manager 1121 performs authentication and authorization based on a login request from the terminal device 1012, the image forming device 1013, and the like. A device is a general term for the terminal device 1012, the image forming device, and the like.

The authentication/authorization manager 1121 accesses tenant information storage 1131, user information storage 1132, device information storage 1133, application information storage 1134, and the like, which will be described later, and authenticates the terminal device 1012, the image forming device 1013, and the like.

The tenant manager 1122 manages tenant information stored in the tenant information storage 1131. The user manager 1123 manages user information stored in the user information storage 1132. The device manager 1124 manages device information stored in the device information storage 1133. The application manager 1125 manages application information stored in the application information storage 1134.

The feature toggle manager 1126 manages feature information stored in feature information storage 1135, which will described later, and manages feature toggle information stored in feature toggle information storage 1136, which will be described later.

Database 1103 includes the tenant information storage 1131, the user information storage 1132, the device information storage 1133, the application information storage 1134, the feature information storage 1135, and the feature toggle information storage 1136.

The tenant information storage 1131 stores tenant information indicating information on tenants that are examples of entities. The user information storage 1132 stores user information indicating information on users that are examples of entities. The device information storage 1133 stores device information indicating information on devices that are examples of entities. The application information storage 1134 stores application information indicating information on applications that are examples of entities. The feature information storage 1135 stores feature information indicating information related to features (functions). The feature toggle information storage 1136 stores feature toggle information indicating information related to feature toggles. In the feature toggle information, entities for which features (functions) are enabled (namely, entities to which features are available) are set. An entity for which a feature is enabled refers to an entity for which the feature is toggled on. Conversely, an entity for which a feature is disabled refers to an entity for which the feature is toggled off.

### <<Information on Each Type>>

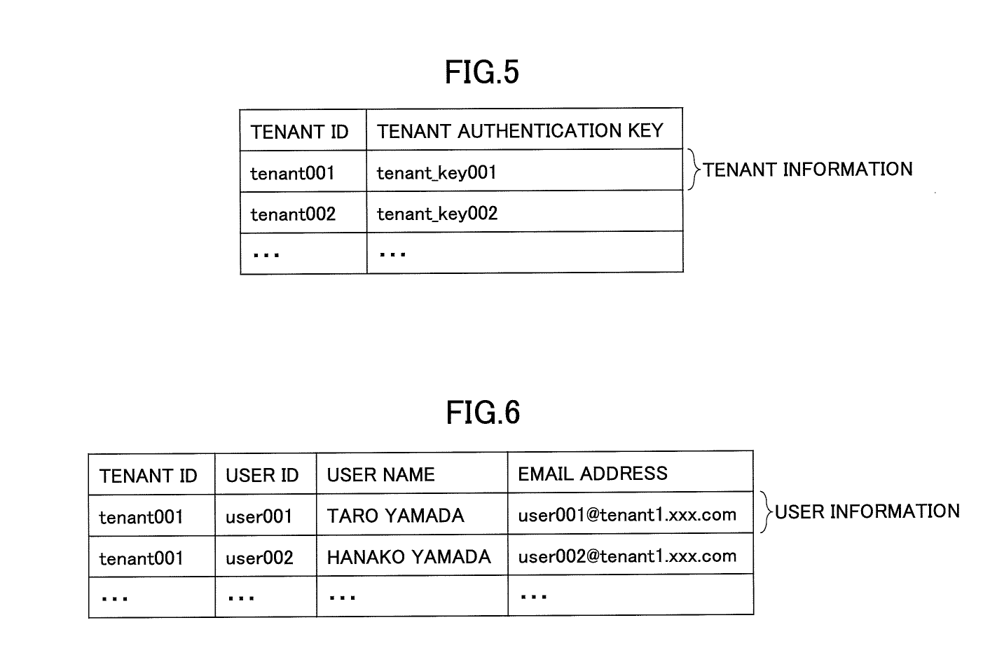

FIG. 5 is a configuration diagram illustrating an example of tenant information. The tenant information in FIG. 5 includes a tenant ID and a tenant authentication key as attributes. The tenant ID is identification information for identifying a tenant. The tenant authentication key is authentication information used to authenticate a tenant.

FIG. 6 is a configuration diagram illustrating an example of user information. The user information in FIG. 6 includes a tenant ID, a user ID, a user name, and an email address as attributes. The tenant ID is identification information for identifying a tenant to which the user belongs. The user name is the full name of the user. The email address is an email address of the user. The user information may include a password used when the user logs in.

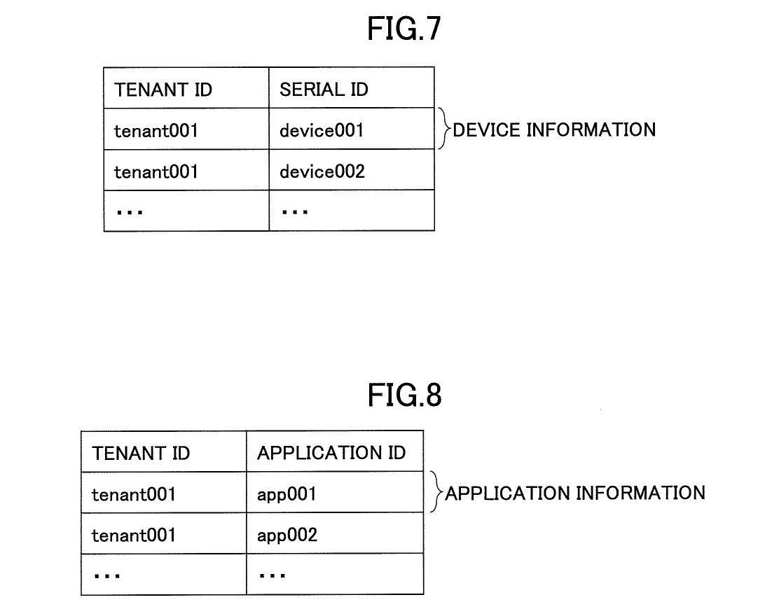

FIG. 7 is a configuration diagram illustrating an example of device information. The device information in FIG. 7 includes a tenant ID and a serial ID as attributes. The tenant ID is identification information for identifying a tenant that has a device indicated by the serial ID. The serial ID is identification information for identifying a device (namely, the terminal device 1012 and the image forming device 1013).

FIG. 8 is a configuration diagram illustrating an example of application information. The application information in FIG. 8 includes a tenant ID and an application ID as attributes. The tenant ID is identification information for identifying tenant that has an application indicated by the application ID. The application ID is identification information for identifying an application.

The application identified by the application ID is not limited to applications included in the applications 1101 (Namely, the application identified by the application ID is not limited to server-side applications running on the service providing system 1014). For example, the application identified by the application ID may be a client-side application running on the terminal device 1012 and the image forming device 1013. The client-side application running on the terminal device 1012 and the image forming device 1013 is hereinafter referred to as a “client application.”

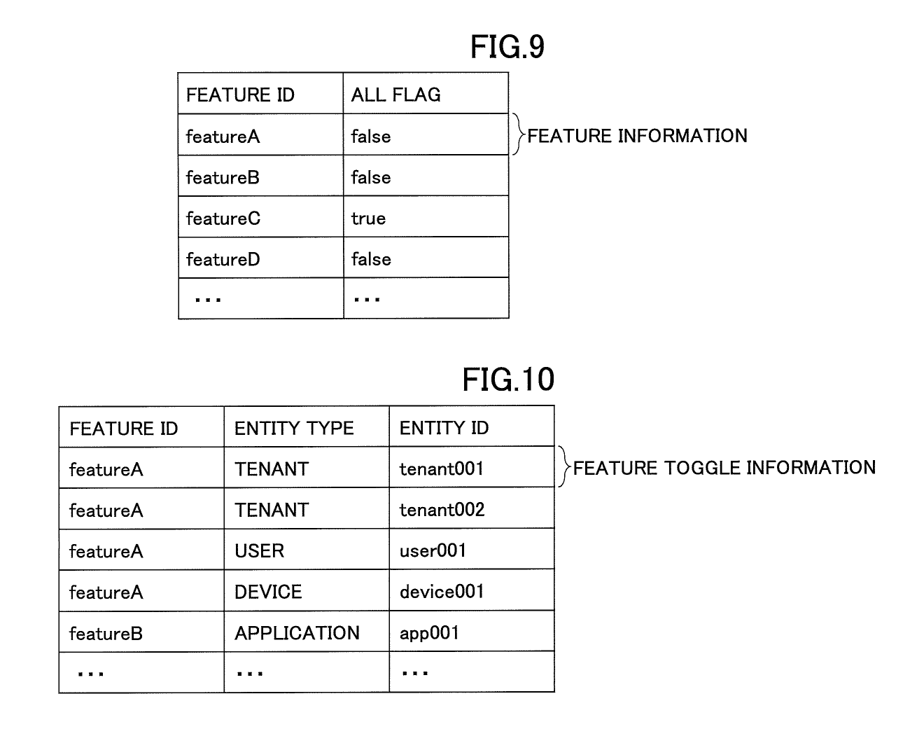

FIG. 9 is a configuration diagram illustrating an example of feature information. The feature information includes a feature ID and an all flag as attributes. The feature ID is identification information for identifying a feature implemented by an application (for example, a feature that stores a scanned electronic file in cloud storage). The all flag is a flag indicating whether the feature is enabled or disabled for all entities. When the all flag of a feature is true, the feature is enabled for all entities (namely, all entities can use the feature). When the all flag of a feature is false, the feature is enabled only for entities associated with the feature, which will be described later.

FIG. 10 is a configuration diagram illustrating an example of feature toggle information. The feature toggle information in FIG. 10 includes a feature ID, an entity type, and an entity ID as attributes. The feature ID is identification information for identifying a feature. The entity type is a type of an entity (such as a tenant, a user, a device, and an application) for which the feature is enabled. The entity ID is identification information for identifying an entity for which the feature is enabled. By associating a feature ID with an entity ID, a specific feature can be enabled only for a certain entity. Therefore, in order to provide a specific feature to a specific entity earlier than other entities, identification information for identifying the entity can be set as the entity ID.

### <Logical Configuration of Feature Toggle>

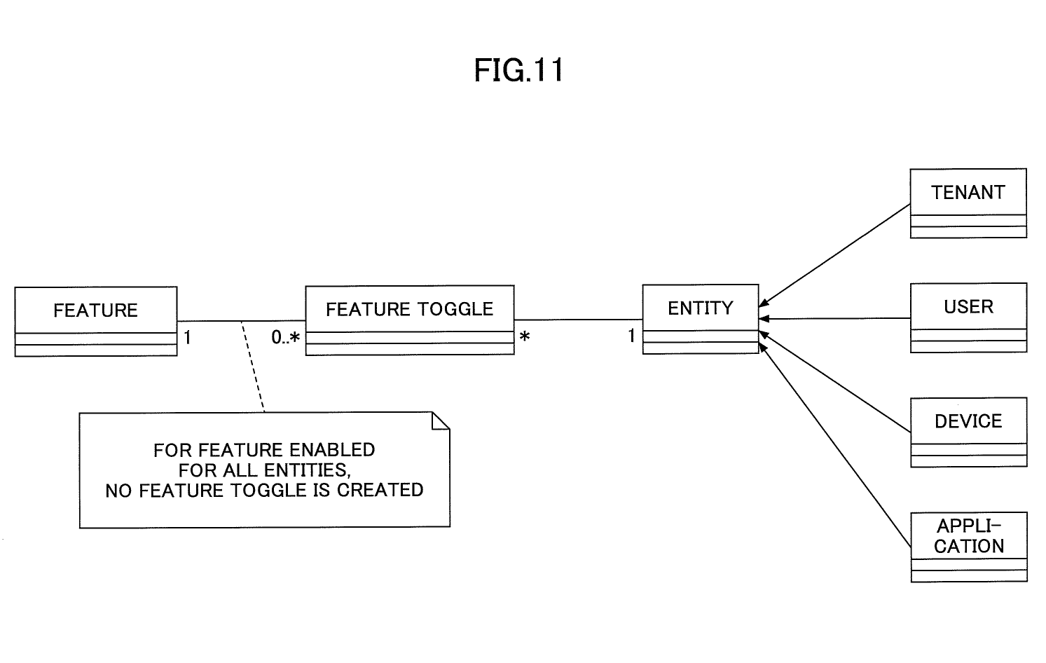

Referring now to FIG. 11, a logical configuration of a feature toggle will be described. FIG. 11 is a diagram illustrating a logical configuration of a feature toggle.

As illustrated in FIG. 11, zero or more feature toggles are associated with a single feature. When no feature toggle is associated with a single feature, this means that the all flag of the feature is true (namely, the feature is enabled for all entities).

Further, as illustrated in FIG. 11, one or more feature toggles are associated with a single entity (an entity is a general term for a tenant, a user, a device, and an application). For example, in order to provide a plurality of features to a specific entity earlier than other entities, a plurality of feature toggles are associated with the entity.

### <Details of Processing>

Next, the details of processing performed by the information processing system 1000 of the present embodiment will be described.

### <<Process of Switching Displays of Available Features Using Feature Toggle>>

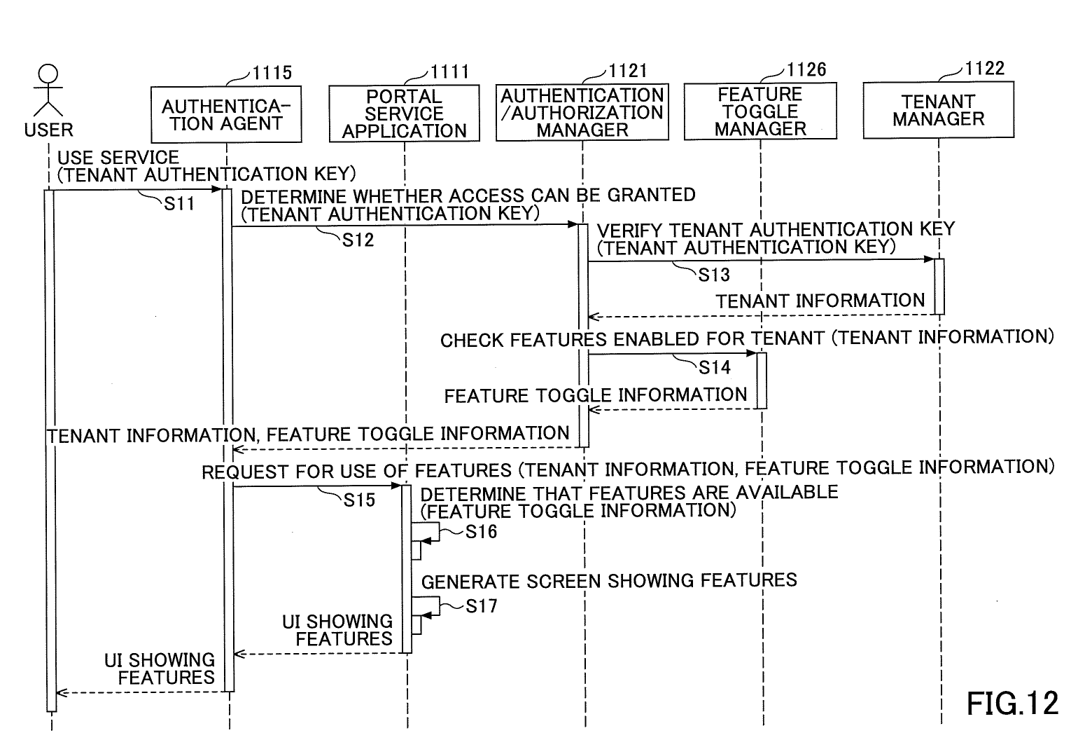

FIG. 12 is a sequence diagram illustrating an example of a process of automatically switching displays of available features using a feature toggle. In the flowchart illustrated in FIG. 12, an example in which a feature toggle is set for a tenant will be described. Also, in the flowchart illustrated in FIG. 12, a user uses the service providing system 1014 by using the terminal device 1012.

First, the user uses the terminal device 1012 to perform an operation to start using a service. The terminal device 1012 obtains a tenant authentication key stored, for example, in the HDD 508, and sends a login request to the authentication agent 1115 (step S11). The login request includes the above-mentioned tenant authentication key, and also includes authentication information such as an authentication ticket stored, for example, in the HDD 508, and the user ID and the password entered by the user.

Once the authentication agent 1115 receives the login request, the authentication agent 1115 requests the authentication/authorization manager 1121 to determine whether an access can be granted (step S12). At this time, the authentication agent 1115 sends the request including the tenant authentication key and the authentication information to the authentication/authorization manager 1121.

The authentication/authorization manager 1121 performs authentication and authorization in response to the request from the authentication agent 1115. Once the authentication and authorization are successful, the authentication/authorization manager 1121 requests the tenant manager 1122 to verify the tenant authentication key (step S13). At this time, the authentication/authorization manager 1121 sends the request including the tenant authentication key to the tenant manager 1122.

Subsequently, the tenant manager 1122 obtains tenant information including the tenant authentication key from the tenant information storage 1131 and responds to the authentication/authorization manager 1121 with the tenant information.

Once the tenant information is sent in response from the tenant manager 1122, the authentication/authorization manager 1121 requests the feature toggle manager 1126 to check features enabled for the tenant (step S14). At this time, the authentication/authorization manager 1121 sends, to the feature toggle manager 1126, the request including the tenant information sent in response from the tenant manager 1122.

The feature toggle manager 1126 responds to the authentication/authorization manager 1121 with feature toggle information including feature IDs of the features enabled for the tenant.

For example, when the tenant ID included in the tenant information is assumed to be “tenant 001,” the feature toggle manager 1126 obtains, from the feature toggle information storage 1136, feature toggle information in which “tenant 001” is set as an entity ID, and responds to the authentication/authorization manager 1121 with the feature toggle information.

The authentication/authorization manager 1121 responds to the authentication agent 1115 with the tenant information sent in response from the tenant manager 1122 and the feature toggle information sent in response from the feature toggle manager 1126.

Once the tenant information and the feature toggle information are sent in response from the authentication/authorization manager 1121, the authentication agent 1115 sends a request for the use of the features enabled for the tenant to the portal service application 1111 (step S15). At this time, the authentication agent 1115 sends, to the portal service application 1111, the request including the tenant information and the feature toggle information sent in response from the authentication/authorization manager 1121.

Once the use of the features is requested from the authentication agent 1115, the portal service application 1111 determines that the features are available (step S16). Namely, the portal service application 1111 identifies the available features based on the tenant information and the feature toggle information included in the request. Next, the portal service application 1111 generates a screen (user interface: UI) displaying the available features (step S17). The portal service application 1111 responds to the user's terminal device 1012 with the generated UI via the authentication agent 1115. Accordingly, the screen (UI) displaying the features available to the user is displayed on the user's terminal device 1012.

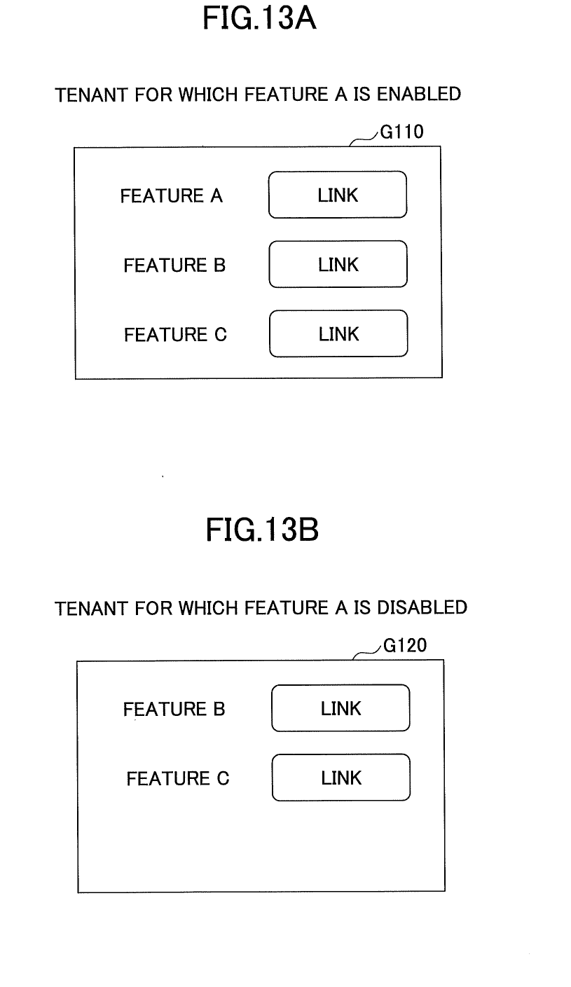

As an example herein, FIGS. 13A and 13B respectively illustrate examples of screens displayed on the terminal device 1012 in respective cases where a feature A is enabled and is disabled for the tenant to which the user belongs. When the feature A is enabled for the tenant to which the user belongs, a screen G110 illustrated in FIG. 13A is displayed. The screen G110 illustrated in FIG. 13A displays a “link” button for using the feature A.

When the feature A is not enabled (namely, disabled) for the tenant to which the user belongs, a screen G120 illustrated in FIG. 13B is displayed. The screen G120 illustrated in FIG. 13B does not display the “Link” button for using the feature A. Therefore, the user is unable to use the feature A.

Accordingly, the service providing system 1014 of the present embodiment allows the use of a feature to be restricted according to an entity that uses a service. Further, although an example in which a feature toggle is set for a tenant has been described with reference to FIG. 12, a feature toggle can also be set for each user, each device, and each application as described above. In such a case, available features are identified and the use of a feature is restricted according to a user, a device, and an application.

### <<Other Examples of Process of Switching Displays of Available Features Using Feature Toggle>>

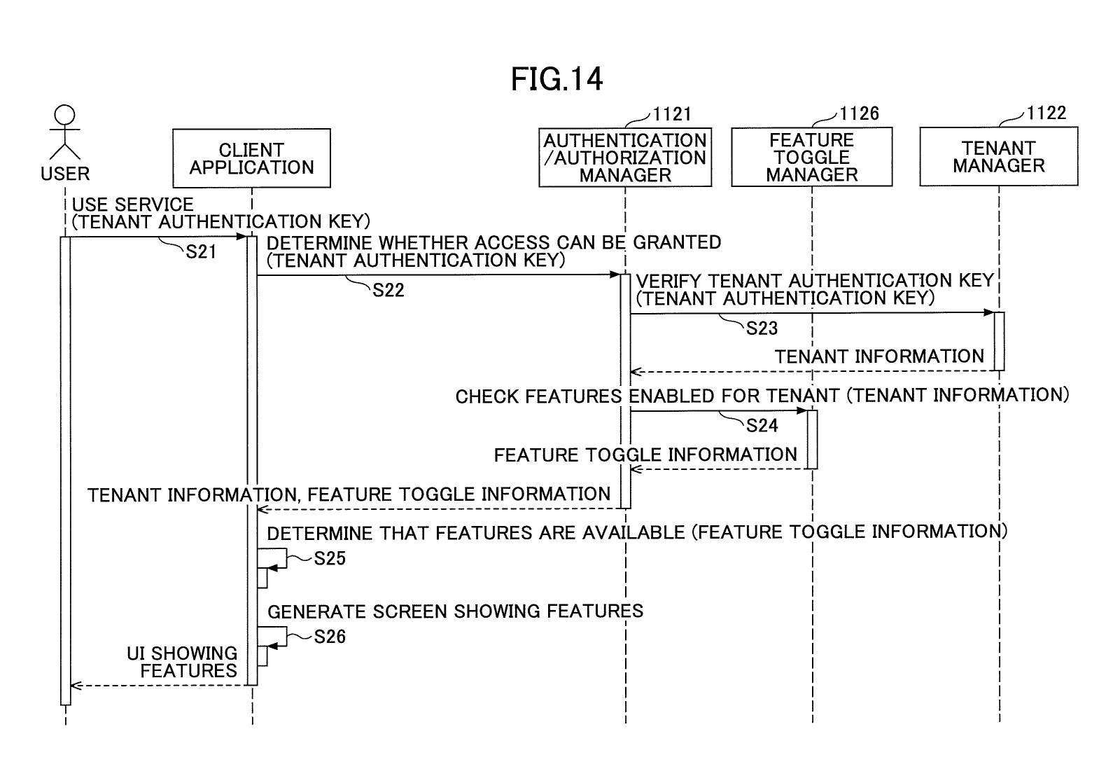

FIG. 14 is a sequence diagram illustrating an example of a process of automatically switching displays of available features using a feature toggle. In the flowchart illustrated in FIG. 12, an example in which a feature is toggled on or off (namely, the use of a specific feature is enabled or disabled) by using the serve-side applications 1101 (for example, the portal service application 1111) running on the service providing system 1014 has been described.

In the flowchart illustrated in FIG. 14, an example in which a feature is toggled on or off by using a client application will be described. Also, in the flowchart illustrated in FIG. 14, a user uses the service providing system 1014 by using the image forming device 1013.

First, the user uses the image forming device 1013 to perform an operation to start using a service (step S21). A client application of the image forming device 1013 obtains a tenant authentication key stored, for example, in the HDD 615, and sends a login request to the authentication/authorization manager 1121 (step S22). The login request includes the above-mentioned tenant authentication key, and also includes authentication information such as an authentication ticket stored, for example, in the HDD 615, and the user ID and the password entered by the user. The client application can send the login request by using a web API, for example.

In response to the login request from the client application, the authentication/authorization manager 1121 performs authentication and authorization. Once the authentication and authorization are successful, the authentication/authorization manager 1121 requests the tenant manager 1122 to verify the tenant authentication key (step S23). At this time, the authentication/authorization manager 1121 sends the request including the tenant authentication key to the tenant manager 1122.

Subsequently, the tenant manager 1122 obtains the tenant information including the tenant authentication key from the tenant information storage 1131 and responds to the authentication/authorization manager 1121 with the tenant information.

Once the tenant information is sent in response from the tenant manager 1122, the authentication/authorization manager 1121 requests the feature toggle manager 1126 to check features enabled for the tenant (step S24). At this time, the authentication/authorization manager 1121 sends, to the feature toggle manager 1126, the request including the tenant information sent in response from the tenant manager 1122.

The feature toggle manager 1126 responds to the authentication/authorization manager 1121 with feature toggle information including feature IDs of the features enabled for the tenant.

The authentication/authorization manager 1121 responds to the client application with the tenant information sent in response from the tenant manager 1122 and the feature toggle information sent in response from the feature toggle manager 1126.

Once the tenant information and the feature toggle information are sent in response from the authentication/authorization manager 1121, the client application determines that the features are available (step S25). Namely, the client application identifies the available features based on the sent in response tenant information and the feature toggle information.

Next, the client application generates a screen (UI) displaying the available features (step S26). The client application displays the generated UI. Accordingly, the screen (UI) displaying the features available to the user is displayed on the operation panel 602 of the user's image forming device 1013.

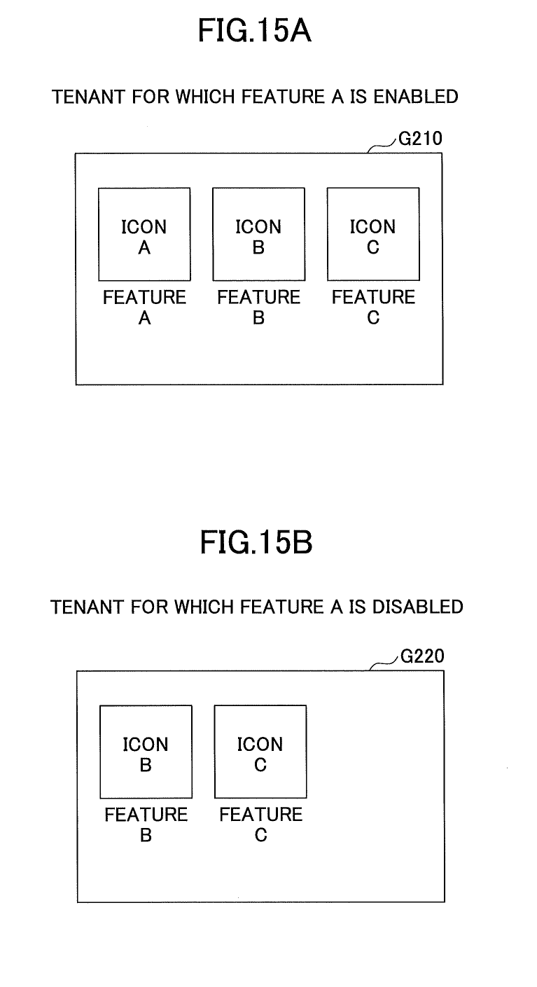

As an example herein, FIGS. 15A and 15B respectively illustrate examples of screens displayed on the image forming device 1013 in respective cases where a feature A is enabled and is disabled for the tenant to which the user belongs. When the feature A is enabled for the tenant to which the user belongs, a screen G210 illustrated in FIG. 15A is displayed. The screen G210 illustrated in FIG. 15A displays an “icon A” button for using the feature A.

When the feature A is not enabled (namely, disabled) for the tenant to which the user belongs, a screen G220 illustrated in FIG. 15B is displayed. The screen G220 illustrated in FIG. 15B does not display the “Link” button for using the feature A. Therefore, the user is unable to use the feature A.

Accordingly, similarly to FIG. 12, the service providing system 1014 of the present embodiment allows the use of a feature to be restricted according to an entity that uses a service. Further, although an example in which a feature toggle is set for a tenant has been described with reference to FIG. 14, the feature toggle can also be set for each user, each device, and each application as described above. In such a case, available features are identified and the use of a feature is restricted according to a user, a device, and an application.

### <Workflow When Feature Toggle is Used>

Examples of workflows using feature toggles will be described in both cases where a service is released to a specific user earlier than other users and the service is released to all users.

### <<Early Release>>

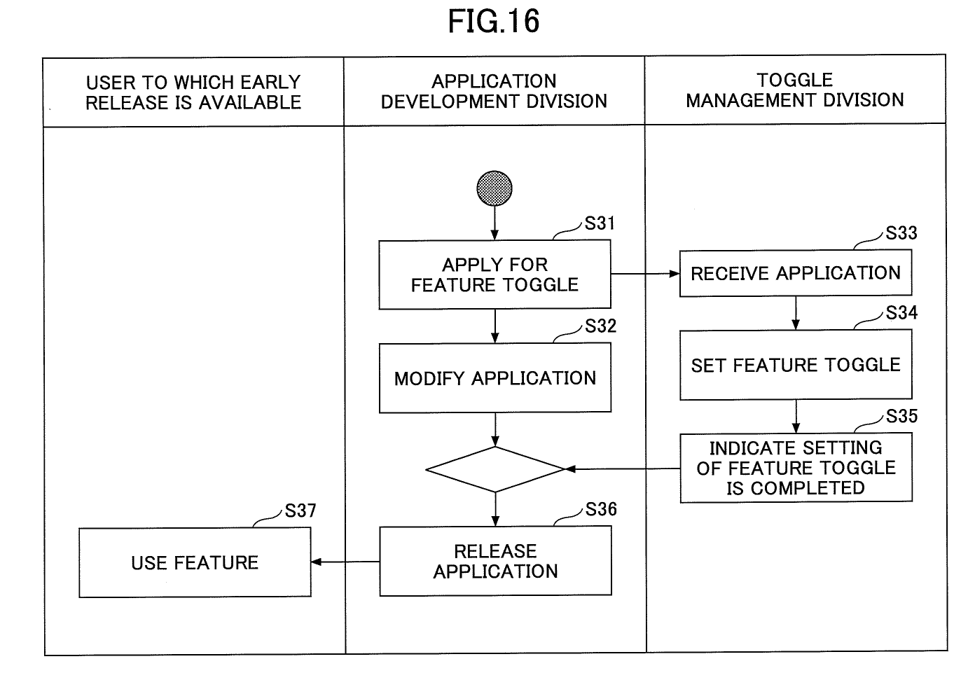

FIG. 16 is a diagram illustrating a workflow for providing a service to a specific user earlier than other users.

First, an application development division applies to a toggle management division to provide an early release to a specific user (S31). Also, the application development division modifies an application by developing a feature allowing a service to be released early and also develops logic allowing the feature to be turned on or off using the feature toggle (S32).

Meanwhile, once the toggle management division receives the application (S33), the toggle management division sets a feature toggle (S34). The feature toggle is set by creating feature information and feature toggle information in accordance with the application, and storing the feature information and the feature toggle information in the feature information storage 1135 and the feature toggle information storage 1136, respectively.

Once the setting of the feature toggle is completed, the toggle management division indicates the completion of the setting of the feature toggle to the application development division (S35).

Once the application development division has received indication from the toggle management division that the setting of the feature toggle is completed, the application development division releases the application modified in S32 above (S36). When the application is released, an entity for which the feature toggle is enabled (namely, the user to which the early release is available) can use the feature released early (S37). Accordingly, the specific service is released to the specific user only.

### <<Release to All Users>>

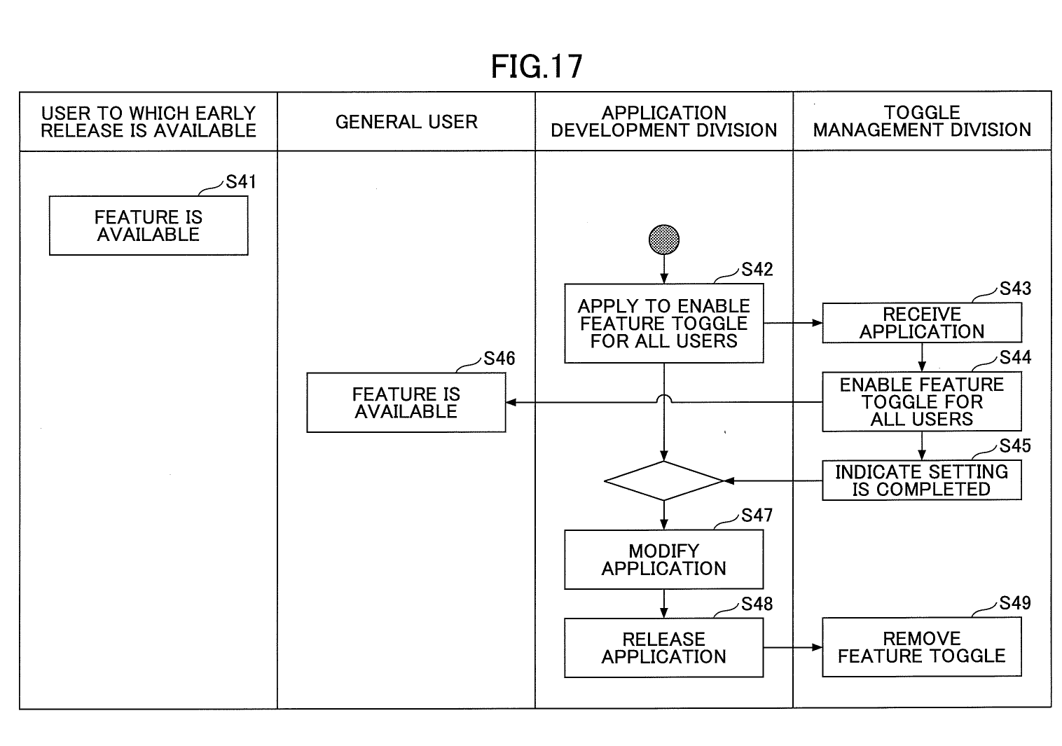

FIG. 17 is a diagram illustrating a workflow for providing a service to all users.

For the feature released to the specific user early (S41), the application development division applies to the toggle management division to enable the feature for all users (S42).

Once the toggle management division receives the application (S43), the toggle management division enables the feature toggle for all users (S44). In order to enable the feature toggle for all users, the all flag included in the feature information is set to true.

Once the toggle management division enables the feature toggle for all users, the toggle management division indicates to the application development division that the feature toggle is enabled for all users (S45).

When the feature toggle is enabled in S44, in addition to the users who have been provided the feature early, other general users become able to use the feature (S46).

Further, the application development division modifies the logic allowing the feature to be turned on or off using the feature toggle (S47), and releases the modified application (S48). The toggle management division removes the feature information and the feature toggle information from the feature information storage 1135 and the feature toggle information storage 1136, respectively (S49).

Accordingly, the service that has been released only to specific users early is released to all users.

According to at least one embodiment of the present invention, restrictions on the use of a service can be flexibly set according to an entity.

Further, the present invention is not limited to these embodiments, but various variations and modifications may be made without departing from the scope of the present invention.

What is claimed is:

1. An information processing system comprising,
at least one information processing apparatus that includes:
a first memory configured to store toggle information that includes entity information indicating either identification information of organizations or identification information of devices and includes identification information of one or more services provided via a network, the one or more services each being associated with at least one of the organizations or the devices; and
a processor coupled to the memory and configured to
obtain, upon receiving a service use request from a given device coupled to the information processing system via a network, from the toggle information stored in the first memory, toggle information that includes entity information indicating either identification information of an organization to which a user of the given device belongs or identification information of the given device,
generate data for displaying one or more of the services indicated by the identification information of the services included in the obtained toggle information as available, and
send the generated data to the given device.

2. The information processing system according to claim 1, wherein
the entity information is the identification information of the organization, the identification information of the given device, or identification information of an application program enabling use of the one or more services, and
the processor is configured to obtain, upon receiving the service use request from the given device coupled to the information processing system via the network, from the toggle information stored in the first memory, toggle information that includes the entity information indicating the identification information of the organization to which the user of the given device belongs, the identification information of the given device, or the identification information of the application program that has requested the service use.

3. The information processing system according to claim 1, comprising,
a second memory configured to store feature information that includes the identification information of the one or more services provided via the network and includes flags that respectively set whether to limit entities enabled to use the one or more services,
wherein the toggle information includes the entity information and includes, from the feature information stored in the second memory, identification information of one or more services included in feature information for which the flags are set to limit the entities.

4. An information processing system comprising,
at least one information processing apparatus that includes:
a first memory configured to store toggle information that includes entity information indicating either identification information of organizations or identification information of devices and includes identification information of one or more services provided via a network, the one or more services each being associated with at least one of the organizations or the devices; and
a processor coupled to the memory and configured to
obtain, upon receiving a service use request from a given device coupled to the information processing system via a network, from the toggle information stored in the first memory, toggle information that includes entity information indicating either identification information of an organization to which a user of the given device belongs or identification information of the given device, and
send the obtained toggle information to the given device.

5. An information processing method used by an information processing system including at least one information processing apparatus, wherein the information processing apparatus includes a first memory configured to store toggle information that includes entity information indicating either identification information of organizations or identification information of devices and includes identification information of one or more services provided via a network, the one or more services each being associated with at least one of the organizations or the devices, the information processing method comprising:
obtaining, upon receiving a service use request from a given device coupled to the information processing system via a network, from the toggle information stored in the first memory, toggle information that includes entity information indicating either identification information of an organization to which a user of the given device belongs or identification information of the given device;
generating data for displaying one or more of the services indicated by the identification information of the services included in the obtained toggle information as available, and;
sending the generated data to the given device.

6. The information processing method according to claim 5, the entity information is the identification information of the organization, the identification information of the given device, or identification information of an application program enabling use of the one or more services, the information processing method comprising:
obtaining, upon receiving the service use request from the given device coupled to the information processing system via the network, from the toggle information stored in the first memory, toggle information that includes the entity information indicating the identification information of the organization to which the user of the given device belongs, the identification information of the given device, or the identification information of the application program that has requested the service use.

7. The information processing method according to claim 5, wherein the information processing apparatus includes a second memory configured to store feature information that includes the identification information of the one or more services provided via the network and includes flags that respectively set whether to limit entities enabled to use the one or more services, and
the obtained toggle information includes the entity information and includes, from the feature information stored in the second memory, identification information of one or more services included in feature information for which the flags are set to limit the entities.
